(19) United States
(12) Patent Application Publication
(10) Pub. No.: US 2008/0066176 A1
(43) Pub. Date: Mar. 13, 2008

(54) Personal digital rights management with user mobility

(75) Inventor: Laurence Hamid, Ottawa (CA)

Correspondence Address: FREEDMAN & ASSOCIATES, 117 CENTREPOINTE DRIVE, SUITE 350, NEPEAN, ONTARIO, K2G 5X3, omitted

(73) Assignee: Memory Experts International Inc., Montreal (CA)

(21) Appl. No.: 11/898,106

(22) Filed: Sep. 10, 2007

Related U.S. Application Data
(60) Provisional application No. 60/842,956, filed on Sep. 8, 2006.

(51) Int. Cl. H04L 9/32

(52) U.S. Cl. 726/21

(57) ABSTRACT

A method of providing authorization, access rights, is provided wherein authentification/authorization for provision of a service is established between the system intended to provide the service and the user granting/limiting the access rights to the service being provided. Accordingly the request for providing a service by a system is communicated to a converged authentication device, typically a wireless device such as a cellular telephone or PDA, wherein authorization of the request is granted/denied. The converged authentification device thereby allowing authorization of the request to be given only by the owner of the access rights.

### FIELD OF THE INVENTION

The invention relates to the field of automated personal digital rights management, and more particularly to the provisioning of automatic verification of access rights with user mobility.

### BACKGROUND OF THE INVENTION

In the past, a household comprised a limited number of electronic devices with discrete and limited functionality. Typically, the household had a telephone, perhaps cordless but linked to a fixed wireline from a service provider, a radio, which received analog broadcasts from providers with fixed radio infrastructure, and a television, receiving perhaps only 2 or 3 television stations with highly regulated content. Today, this household will now typically contain several radios, the radios receiving both digital and analog broadcast signals, several televisions, with typically receiving digital television signals and approaching hundreds of available channels some of which have unregulated or poorly regulated content and are optionally satellite and/or cable based, several telephones, which are generally wireless devices, personal computers which allow not only traditional functions but also Internet access, web browsing and the streaming of audio and visual content from thousands of other content providers, game consoles and PDAs.

In many instances the household only takes the basic standard packages from the service providers of its cable television, satellite television, telephony, Internet access etc. As such the users within the household pay additionally for being provided additional specific services, typical examples being provision of a Sports package or pay-per-view movie network on their cable. As such these services are currently restricted to the physical household, and in some instances limited to a specific set-top box or gateway, and are not portable with the user so that for example they cannot access the Sports channel when at a friend's house. Alternatively the user is currently watching a pay-per-view movie and misjudges the time before they need to leave home to catch a bus to work, they cannot currently transfer the pay-per-view movie to their wireless telephone to continue viewing.

Further with the plurality of media devices and the explosion in the available content providers across these many devices it has become increasingly difficult to provide adequate policing of children's access to inappropriate content. One prior art approach to policing content is known as the V-Chip, which allows blocking of certain content, based upon signaling information provided within a television signal. Unfortunately, V-chip is embedded into the television and if the video content is steamed into their personal computer and displayed the V-chip is bypassed.

As such the issues of content management, content portability and policy in today's world of converging multi-media electronics and service providers are complex and existing solutions fail to account for both the complexity of the problem and the rapid evolution of multi-media devices which essentially obsolete these prior art solutions in a very short time.

It would therefore be advantageous to provide an approach to content management, content portability and content access policy that exploited this very highly advanced infrastructure of electronics, especially wireless based ones, such that a user can manage directly these issues no matter where they are physically in respect to the content being accessed.

### SUMMARY OF THE INVENTION

In accordance with the invention there is provided a method of rights management for content display comprising providing a content display, the content display comprising a means of providing a content to a user, a first microprocessor for at least controlling the content display in response to a permission signal relating to providing of the content, a first communications port, the first communications port for receiving a request to provide the content, and a second communications port, the second communications port for communication of at least providing a first message relating to the request and receiving a second message relating at least to establishing the permission signal. The method further comprising providing at least a remote authorization device of a plurality of authorization devices, each remote authorization device associated with an owner and comprising at least one of a memory, a second microprocessor, and a third communications port, the third communications port at least receiving the first message and providing the second message.

In accordance with another embodiment of the invention there is provided a method of rights management comprising providing a system, the system for providing a function to a user and comprising a system microcomputer for at least controlling the system in response to a permission signal, a first communications port, the first communications port for receiving a request to provide the function, and a second communications port, the second communications port for communication of at least providing a first message relating to the request and receiving a second message. The method further comprising a remote authorization device, the remote authorization device comprising at least one of a memory, a device microcomputer, and a third communications port, the third communications port at least receiving the first message and providing the second message; wherein the second message relates at least to establishing the permission signal for the providing of the function by the system.

In accordance with another embodiment of the invention there is provided a method of rights management comprising:

(a) providing a content service provision device supporting broadcasts with at least one protocol of a plurality of broadcast protocol;

(b) requesting a content service event of a plurality of different content service events, the plurality of content service events associated with at least one content service provider of a plurality of content service providers operating with a same broadcast protocol;

(c) issuing from the content service provision device a request signal;

(d) awaiting a reply; and

(e) receiving the reply and in dependence of the reply at least one of providing the content service event and other than providing the content service event.

### BRIEF DESCRIPTION OF THE DRAWINGS

Exemplary embodiments of the invention will now be described in conjunction with the following drawings, in which:

FIG. 1 shown is a first embodiment of the invention, provided as a converged authentication device in communication with a television for controlling rights to viewing.

FIG. 2 shows an exemplary flow diagram for a method of selecting one of N wireless converged authentication devices.

FIG. 3 shows an exemplary flow diagram for a method of automatically selecting one of N wireless converged authentication devices.

FIG. 4 shows an exemplary flow diagram of a method of providing service in the presence of multiple wireless converged authentication devices.

FIG. 5 shows an exemplary flow diagram of a method with established rules applied with multiple wireless converged authentication devices.

FIG. 6 shows an exemplary flow diagram of a method of authorizing viewing and billing with a wireless converged authentication devices.

FIG. 7 shows an exemplary flow diagram of a method of invoicing an individual relating to one converged authentication device when another individual requests a billable event.

FIG. 8 shows a flow diagram for a scenario as each individual enters and/or leaves the space, their wireless converged authentication device is authenticated and their permissions and configuration is noted.

### DETAILED DESCRIPTION OF EMBODIMENTS OF THE INVENTION

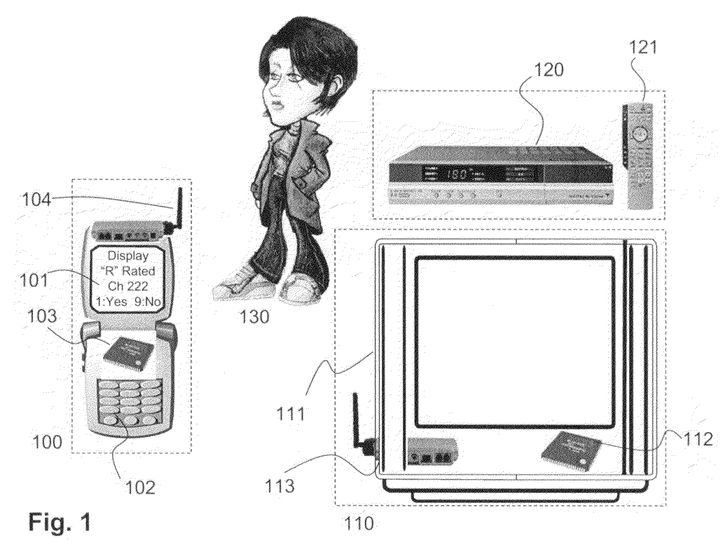

Referring to FIG. 1 shown is a first embodiment of the invention, provided as a converged authentication device in communication with a television 110 for controlling rights to viewing. The converged authentication device shown is in the form of a Bluetooth™ cellular telephone 100 for wireless communication with a television 110 and a digital set-top box 120 for the content providing device, television 110. As shown the Bluetooth™ cellular telephone 100 includes a display 101, a keyboard 102, a microcomputer 103, and a wireless transceiver 104. Similarly the television 110 comprises a display 111, a microprocessor 112, a wireless transceiver 113 and a communications port, which is not shown for clarity. The digital set-top box 120, having associated with it a handheld controller 121, generally in the form of a remote control handset, and a communications port, not shown for clarity.

A user 130 upon wishing to select a channel for viewing on the television 110 selects the channel they wish to view by using the handheld controller 121 to enter the channel number into the digital set-top box 120. This information is transferred from the digital set-top box 120 to the television 110 by means of the communications port, which can for example be via wired connection, infrared link or wireless link. The television 110 upon receipt of the channel information provides this to the microprocessor 112, which notes that the channel selected is rated as “R” and has been defined as restricted access in the configuration settings of the television, which are stored within the microprocessor 112. The television 110 now transmits a request message using its wireless transceiver 113 for authorization to access the content.

In this exemplary embodiment the Bluetooth™ cellular telephone 100 is within immediate range of the television 110 and receives via its wireless transceiver 104 the request message. Alternatively the Bluetooth™ cellular telephone 100 may not be within immediate range but be physically with an individual having permission rights of the location wherein the television 110 and digital set-top box 120 are located. This request message is fed to the microcomputer 103, which triggers a message to be displayed on the display 101 of the Bluetooth™ cellular telephone 100. This message states, for example, “Request to Access Adult Sex Channel—Select 1 to Authorize, Select 9 to Block”. Upon the user of the Bluetooth™ cellular telephone 100 entering either ‘1’ or “9” to the keyboard 102 of the Bluetooth™ cellular telephone 100 then a message is transmitted from the Bluetooth™ cellular telephone 100 to the television 110. The microprocessor 112 of the television 110 then decoding the message and either authorizing or blocking the content. It would also be evident that the user 130 of the Bluetooth™ cellular telephone 100 could communicate with the location to clarify who is requesting the access prior to providing his response.

Many alternative embodiments of the invention are possible, including but not limited to those outlined below. Also, applications and devices described are optionally any electronic device, application and that the communications protocols are optionally any adopted standard or alternatively a proprietary communication protocol. For example, the user 130 may be a manager of a business team, and the request message relates to another user seeking to access a remote computer via the Internet and perform FTP operations. Optionally, the request may be associated with a point of sale terminal poling a cellular telephone identified with a financial instrument, such as a credit card, when the value of the transaction exceeds a predetermined limit, thereby allowing for example a parent to authorize transactions for a teenager having the financial instrument to perform regular activities such as purchasing meals, etc but allowing the predetermined limit to be exceed by prior agreement, wherein the parent is expecting the request, or in an emergency.

Accordingly; embodiments of the invention allow for increased rights management to a variety of events including but not limited to the audio-visual information that forms the basis of discussions below. Such increased rights management including but not limited to:

Converged Authentification wherein an electronic device, such as the television 110, polls a predetermined external device, including but not limited to a wireless device such as Bluetooth™ cellular telephone 100, to establish the rights for displaying or accessing audio-visual content. Such content authentification may for example be established as automatic, such as if the wireless device is polled directly from the electronic device, based upon user entered information, or the users agreement to transfer from their wireless device the authorization codes for a particular service. As such additional embodiments are optionally foreseen including removing storage of authorization codes from the multi-media devices thereby providing not only increased policing of the content but also security, and an ability to bill the individual providing the authorization codes irrespective of their household location and current location. Hence, for example, a user can authorize the “NBA League Pass” they pay for and normally view at home when at a friend's house by providing the codes to their friend's set-top box which deletes them after a predetermined period.

Embodiments of the invention exist not only for the visual content delivery as generally described but to any audio-visual system including but not limited to cellular telephones, personal computers, gaming consoles, entertainment consoles, PDAs, radios. Examples include, but are not limited to, a parent restricting the use of a telephone by their children, a sibling may restrict access to their gaming console by other siblings, restricting access to a radio station considered inappropriate by the parents etc.

Approaches outlined herein are optionally extended to a variety of other systems. Such examples including, but not being limited to, restricting the operation of a motor vehicle such that it's maximum speed is restricted when operated by say the 18 year old daughter of the family and unrestricted when permitted by the parent(s), or the motor vehicle will not start unless authorized by the parent(s). Embodiments in other fields can also be envisaged such as authorizing a charge to a financial instrument through the actions of another person prior to the transaction being completed. Hence, a manager can give access to a credit card to an employee and restrict it to say $500 purchases or specific retailers but can authorize other purchases.

Converged Device Content wherein the user not only authorizes a content to be provided but also controls the device to which that content is provided. Exemplary examples could include the content is only provided to the television which is in direct communication with the external electronic device providing authorization such that only a single television within the household displays that content, and that content optionally moves to another television as the user moves say from kitchen to lounge, or from lounge to bedroom. Optionally, the content is authorized to port from the television where the user is currently watching it to their portable telephone as they leave the house to go to work, visit a friend, or sit in the garden etc.

In other embodiments a Service Provider is the provider of either the authorization and authentification codes based upon the provision of user communications from their polled portable device. As such a user establishes authorization codes for accessing specific content; such codes are optionally secret to the user such as being generated by a secure encryption algorithm in response to a biometric authentification of the user, such that only messaging from their polled portable device triggers the use of them and their release. As such increased security is optionally supported as passwords for accessing sensitive material, such as adult or business materials etc, need not be memorized and hence easily guessed or seen by others.

Tagging Content and Content Organization. In other embodiments, the content stored within an electronic device, such as a PVR, rewritable CD or DVD, hard disk etc is optionally tagged such that it is only accessible at any later point in time with the provision of the correct authorization code(s). Optionally, the information is organized based upon such tagging and hence only content information at the appropriate authorization level is displayed on a media player or alternatively content associated with the authorization device. As such a personal computer would not list or display specific files or directories, such as containing perhaps adult video content downloaded by the parents, to the parent's children when they access the computer. Such tagged content organization enhancing security as the content is hidden irrespective of the user account currently in use, thereby eliminating problems from forgetting to log out. Equally, a service provider displays only “PG” movies or only the titles of “PG” movies on a “Pay-per-View” screen if the authorization were only at that level. It would be evident that many other embodiments are possible to ease content management and content policing.

Embodiment of the invention allow for an authenticator to make requests to the user, exemplary examples including but not limited to:

The authenticator requests from the user to provide authorization, optionally via messaging, provision of additional passwords, stored passwords, stored keys and other approaches well known to those for managing granting access to information. In such embodiments the separation of the user and their entry device for authorization from the device requesting authorization to display content allows increased freedom as now the user does not need to be logged into the actual device or system requesting authorization. For example in one embodiment a user has securely stored authorization codes to eBay, an online auction service provider, with Verizon, their prime telecom content provider, then if they receive a “Buy Now” email on their cellphone and wish to purchase the item they do not need to have the authorization codes present, they merely need to send authorization to Verizon to use their eBay authorization codes.

Additionally, the request for user authorization is typically one that would be handled during the normal activities of a user, so the user upon receiving a request may be busy, and thereby provides a “Notify Me Later” reply such that the request is repeated at a predetermined period of time later. This allows the user to contact, for example, their household to find out who is requesting a particular service. Such delays optionally allowing a user to perform other types of research prior to authorizing a transaction. Alternatively, the user receives the message, stores it for subsequent retrieval, performs what ever actions are required to determine the validity of the request or their response, retrieves the message and enters the necessary response. Such approaches allowing the user to receive a voice request, make a telephone call, and reply to the request upon a cellular telephone.

Embodiments of the invention relate to registration of users and include but are not limited; controlling who within a household, business, family etc can register to receive specific services or content, optionally controlling what may be undertaken with a specific electronic device by each individual, such as for example enforcing a punishment to one sibling of a no “MSN Messaging”, web browsing, email etc but allowing another sibling to continue such activities without requiring the parent be present to police the activities. Alternative embodiments could for example be temporal control, so establishing watershed times for providing access to different content such as violent films, adult themed TV series etc or re-directing content from one device to another, such as “no emails from work to be redirected to cellphone after 6 pm.”

Other embodiments include auto-registration functions such that user entry is not required, but the event is logged, such as the babysitter always accesses adult TV or browses pornography. Such auto-registration are optionally always allow, always block, and other variants evident to those skilled in the art.

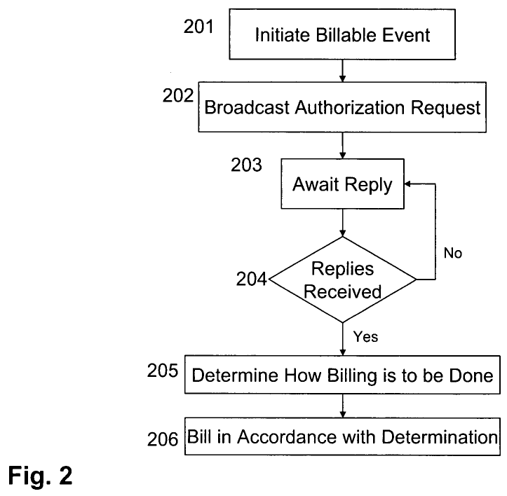

Referring to FIG. 2 there is shown an exemplary flow diagram of method of selecting one of N wireless converged authentication devices. It would be evident to one skilled in the art that when using a wireless converged authentication device, there exists a drawback if several wireless converged authentication devices are present within communication range of a particular system, as conflicts between the wireless converged authentication devices may occur and the authorizations given. Shown in FIG. 2 is an exemplary flow-diagram for selecting which converged authentication device a satellite television receiver relies upon for authentication, permission setting, and billing purposes, thereby avoiding issues such as double billing, permissions being inappropriately set, etc.

As such at step 201 a billable event is triggered, for example accessing “Playboy TV” by a group of friends during an evening. Execution of step 201 causing in step 202 an authorization request to be broadcast, for example using a Bluetooth™ transceiver such that any Bluetooth™ enabled device within range, typically 10 meters, receives the request. Having issued the request the process moves to a loop comprising a wait step 203 and received reply determination in step 204 such that the process holds until at least one response is received. Upon determining that replies have been received the process moves forward to step 205 wherein a determination of how billing is to be undertaken. For example, split charge equally to all respondents, bill respondents according to the total duration their Bluetooth™ enabled device is within communication range of the Bluetooth™ transceiver. Having made the determination the process moves to step 206 and bills in accordance with the determination made previously in step 205.

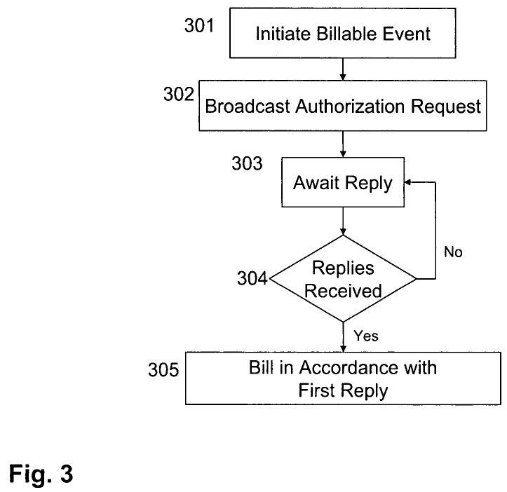

Referring to FIG. 3, there is shown an exemplary flow diagram for a method of automatically selecting one of N wireless converged authentication devices. As such at step 301 a billable event is triggered, for example accessing “NBA League Pass” by a group of friends during an evening. Execution of step 301 causing in step 302 an authorization request to be broadcast, for example using a Bluetooth™ transceiver, such that any Bluetooth™ enabled device within range, typically 10 meters, receives the request. Having issued the request the process moves to a loop comprising a wait step 303 and received reply determination in step 304 such that the process holds until at least one response is received. Upon determining that at least a reply has been received the process moves forward to step 305 and bills for the billable event in accordance with the first reply received.

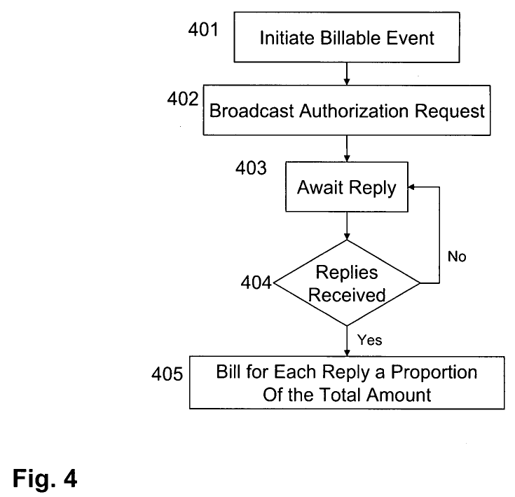

Referring to FIG. 4, there is shown an exemplary flow diagram of a method of providing service in the presence of multiple wireless converged authentication devices. As such at step 401 a billable event is triggered, for example accessing “Harry Potter and the Order of the Phoenix” from the movies on demand section of their digital television provider by a group of friends during an evening. Execution of step 401 causing in step 402 an authorization request to be broadcast, for example using a Bluetooth™ transceiver, such that any Bluetooth™ enabled device within range, typically 10 meters, receives the request. Having issued the request the process moves to a loop comprising a wait step 403 and received reply determination in step 404 such that the process holds until at least one response is received. Upon determining that at least a reply has been received the process moves forward to step 405 and bills for the billable event in dependence of the number of replies received.

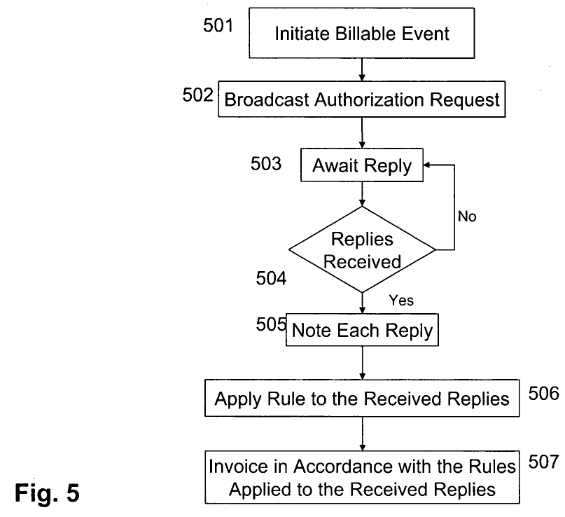

Referring to FIG. 5, there is shown an exemplary flow diagram of a method of with established rules applied with multiple wireless converged authentication devices. As such at step 501 a billable event is triggered, for example accessing “Opening Ceremony—Beijing Olympics” in high definition (HD) from the BBC by a group of friends during an evening. Execution of step 501 causing in step 502 an authorization request to be broadcast, for example using a Bluetooth™ transceiver, such that any Bluetooth™ enabled device within range, typically 10 meters, receives the request. Having issued the request the process moves to a loop comprising a wait step 503 and received reply determination in step 504 such that the process holds until at least one response is received. Upon determining that at least a reply has been received the process moves forward to step 505 and notes each received reply. In step 506 the process applies a predetermined rule to the received replies. The invoices for the billable event are then issued in accordance with the rules applied to the received responses in step 507.

For example, in the above household scenario, a priority list is created and the wireless converged authentication device with the highest priority is selected for determining billing information. Optionally within a corporate environment the rules optionally involve more complex division of costs between departments based on the wireless converged authentication devices present or based on those that respond.

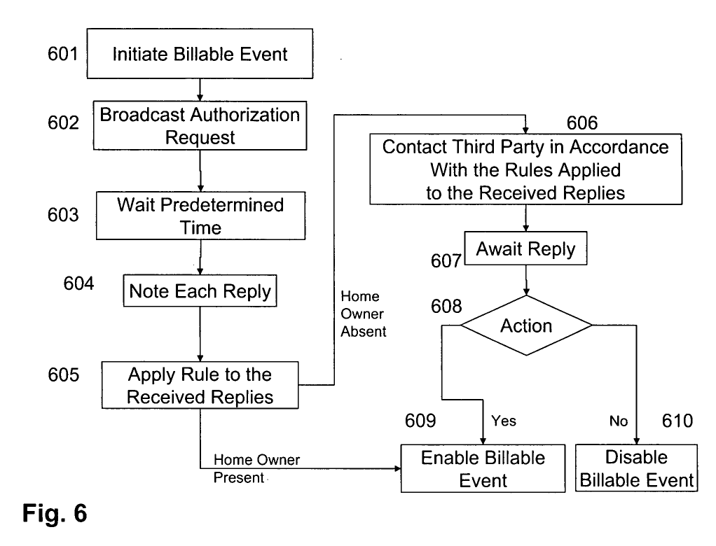

Referring to FIG. 6, there is shown an exemplary flow diagram of a method of authorizing viewing and billing with a wireless converged authentication devices. As such at step 601 a billable event is triggered, for example accessing “Game 5—Stanley Cup 2007” in high definition (HD) from the FOX Television by a sibling of the home owner and group of friends. Execution of step 601 causing in step 602 an authorization request to be broadcast, for example using a Bluetooth™ transceiver, such that any Bluetooth™ enabled device within range, typically 10 meters, receives the request. Having issued the request the process moves to wait step 603 and holds for a predetermined time, such as for example one minute. Upon completing the predetermined hold the process moves forward to step 604 and notes each received reply. In step 605 the process applies a predetermined rule to the received reply(ies) in order to determine if the home owner is present, for example the mother, father, or another designated with appropriate authorizations such as grandfather. If upon determining a home owner is present the process moves forward to step 609 and the billable event is enabled.

If, however, the home owner is not present the process moves forward to step 606 and contacts a third party, e.g. the father, in accordance with the rules. This contact being for example by triggering an electronic message from FOX Television to a predetermined cellular device of the third party. At step 607 the process awaits a reply from the third party, and upon receipt moves forward to step 608. If the response is positive then the process moves forward to step 609 and the billable event is enabled. If, however, the response is not positive then the process moves forward to step 610 and the billable event is not enabled.

Alternatively, the process was triggered by a 14 year old requesting an “18” rated film through pay-per-view. If the parents are not present, such that the rule applied in step 605 triggers the process to move forward to step 606 and contact a third party the film title and details, the wireless converged authentication device associated with the 14 year old replying in step 604 and the cost are conveyed to a parent via a cellular telephone link and the parent is provided the opportunity to allow or disallow the request.

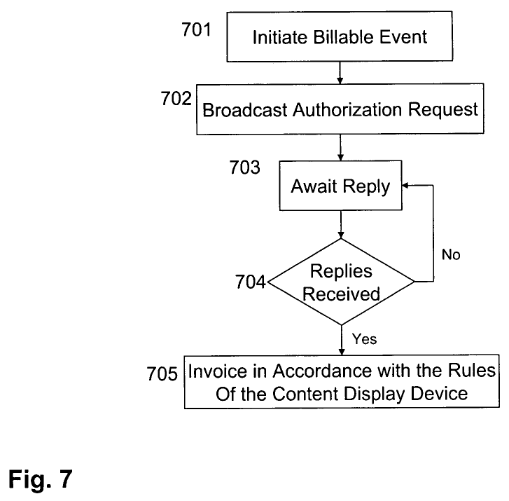

Referring to FIG. 7, there is shown an exemplary flow diagram of a method of invoicing an individual relating to one converged authentication device when another individual requests a billable event. As such at step 701 a billable event is triggered, for example accessing “Harry Potter and the Order of the Phoenix” from the movies on demand section of a digital television provider by a group of guests during an evening hosted by an individual. The content display device being the home theatre system of the host, but optionally another television within their house. Execution of step 701 causing in step 702 an authorization request to be broadcast, for example using a Bluetooth™ transceiver, such that any Bluetooth™ enabled device within range, typically 10 meters, receives the request. Having issued the request the process moves to a loop comprising a wait step 703 and received reply determination in step 704 such that the process holds until at least one response is received. Upon determining that at least a reply has been received the process moves forward to step 405 and bills for the billable event in dependence of the rules of the content display device. Absence of a reply in the preceding steps would not cause the billable event to be triggered.

For example, the rule may have been set by a host for this discontent display device to invoice themselves when their guests use the device. A guest with his or her own converged authentication device thereby validates the requested event causing it to be displayed but the host is invoiced. Alternatively, the host is prompted before being invoiced. Optionally, the identity of the validating guest is stored or provided to the host. Of course, any number of configurations and options are supported and are preferably user configurable.

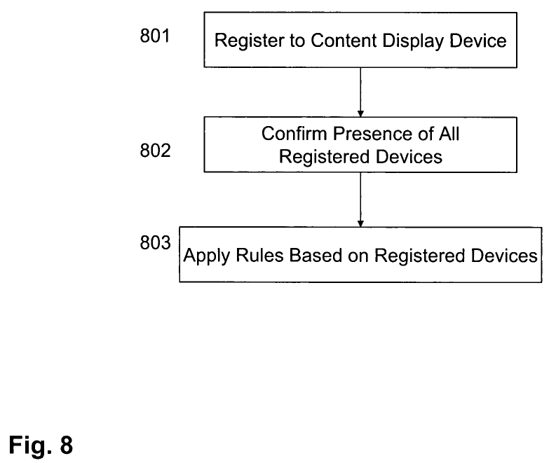

Referring to FIG. 8, a wireless converged authentication device is used to provide “follow me” functionality. Within the prior art considerable work has been undertaken to support “follow me” functionality, wherein a service being accessed by a user is available wherever the user currently is. For example, Sun® provides a mobile desktop platform, the SunRay™, which allows a user to move from one workstation to another workstation with their desktop automatically following them. Unfortunately, when used with wireless converged authentication devices there exists the problem of who is being followed when more than a single wireless converged authentication devices is within a space.

Accordingly to the flow shown in FIG. 8, as an individual enters and/or leaves the space associated with a content display device, then their wireless converged authentication device is registered with the content display device in step 801. In step 802 authentification of the individual occurs by confirming the presence of registered devices, and the permissions associated with the individuals, and configuration of individuals are noted. A set of rules are then processed in step 803 for determining permissions, etc. that are applicable in view of each wireless converged authentication device registered. For example, the rules may provide a union of permissions. This is useful for a content display device such as a satellite television receiver, thereby providing a maximum number of available channels as permissions of each user are combined. Hence, a user with “NBA League Pass” would enable these additional channels as would a second user present with “NHL On-Demand”.

Alternatively, the least permissions are established from the rules by providing an intersection of permissions. This is useful when safety or content blocking is desired. If within a group of users, one user is present with wireless converged authentication device that indicates they are a child, then no adult content is displayed by the content display device. Alternatively, if someone without permission is present, then certain functions may be prevented or content disabled. Of course, more complex rules are supported such that permissions are only grouped in certain cases with certain restrictions. Optionally, the conditions and restrictions are stored within the wireless converged authentication devices and communicated during registration. For example, a father may allow their child to watch “18” movies if they are present within a group but not if they are absent from the group.

Though the above examples use a wireless converged authentication device for communication with a local content display device, the invention is applicable to other services and also to wireless converged authentication devices that communicate through networks such as computer networks, cellular communication networks, etc.

Numerous other embodiments may be envisaged without departing from the spirit or scope of the invention.

What is claimed is:

1. A method of rights management for content display comprising:
(a) providing a content display, the content display comprising a means of providing a content to a user, a first microprocessor for at least controlling the content display in response to a permission signal relating to providing of the content, a first communications port, the first communications port for receiving a request to provide the content, and a second communications port, the second communications port for communication of at least providing a first message relating to the request and receiving a second message relating at least to establishing the permission signal; and
(b) providing at least a remote authorization device of a plurality of authorization devices, each remote authorization device associated with an owner and comprising at least one of a memory, a second microprocessor, and a third communications port, the third communications port at least receiving the first message and providing the second message.

2. A method according to claim 1 wherein,
providing the second message comprises providing the second message at least one of automatically from the at least a remote authorization device receiving the first message and in dependence of a response provided by a user of the at least a remote authorization device.

3. A method according to claim 1 wherein,
providing the first message comprises providing the first message to at least one predetermined address of a remote authorization device and broadcasting the first message to all remote authorization devices within a predetermined range of the content display device.

4. A method according to claim 1 further comprising:
(c) determining that a second message received by the content display relates to a valid authorization to display the content in response to the request;
(d) providing at least an invoice upon determining a valid authorization, the invoice being determined at least in dependence of a cost associated with the content.

5. A method according to claim 4 wherein,
providing the at least an invoice comprises providing the at least an invoice to the owner of at least one of the remote authorization device providing the valid authorization and all remote authorization devices providing second messages in response to the first message.

6. A method according to claim 1 further comprising:
(c) establishing the permission signal relating to the providing of the content, the permission signal determined at least in dependence upon at least one of a set of rules stored within a memory associated with the first microprocessor, the first second message received, and all second messages received.

7. A method according to claim 6 further comprising:
(d) determining that none of the received second messages relate to an owner with a remote authorization device having a sufficient right to authorize the requested content;
(e) generating a third message in dependence upon at least the request and an owner of a remote authorization device providing a second message with insufficient rights; and
(f) providing the third message from the content display to a predetermined remote authorization device, the predetermined remote authorization device associated with a user having the sufficient right.

8. A method according to claim 1 wherein,
providing the request relates to providing a request to provide content having at least one of a minimum age requirement, a distribution list of allowed viewers, encryption requiring provision of a key for decryption, and a protection requiring a password to release.

9. A method according to claim 1 wherein,
providing a second message comprises providing a second message containing a valid authorization to display the content for a predetermined period of time.

10. A method according to claim 9 wherein,
after the predetermined period of time the content display provides a third message relating to the request and continuing the display and must receive a fourth message relating at least to maintaining the permission.

11. A method according to claim 10 wherein,
the fourth message originates from at least one of the same remote authorization device as that providing the valid authorization and a remote authorization device associated with an owner of the content display.

12. A method according to claim 1 wherein,
the request relates to content for display on the content display that is associated with a content delivery service that is not part of the services authorized by the owner of the content display.

13. A method of rights management comprising;
(a) providing a system, the system for providing a function to a user and comprising a system microcomputer for at least controlling the system in response to a permission signal, a first communications port, the first communications port for receiving a request to provide the function, and a second communications port, the second communications port for communication of at least providing a first message relating to the request and receiving a second message; and
(b) a remote authorization device, the remote authorization device comprising at least one of a memory, a device microcomputer, and a third communications port, the third communications port at least receiving the first message and providing the second message; wherein
the second message relates at least to establishing the permission signal for the providing of the function by the system.

14. A method according to claim 13 wherein, providing the second message comprises providing the second message at least one of automatically from the at least a remote authorization device receiving the first message and in dependence of a response provided by a user of the at least a remote authorization device.

15. A method according to claim 13 wherein,
providing the first message comprises providing the first message to at least a predetermined address associated with the at least a remote authorization device and broadcasting the first message to all remote authorization devices within a predetermined range of the content display device.

16. A method according to claim 13 further comprising:
(c) determining that a second message received by the system relates to a valid authorization to provide the function in response to the request;
(d) providing at least an invoice upon determining a valid authorization, the invoice being determined at least in dependence of a cost associated with the function.

17. A method according to claim 16 wherein,
providing the at least an invoice comprises providing the at least an invoice to the owner of at least one of the remote authorization device providing the valid authorization and all remote authorization devices providing second messages in response to the first message.

18. A method according to claim 13 further comprising:
(c) establishing the permission signal relating to the providing of the function, the permission signal determined at least in dependence upon at least one of a set of rules stored within a memory associated with the system microcomputer, a set of rules associated with the function, the first second message received, and all second messages received.

19. A method according to claim 18 further comprising:
(d) determining that none of the received second messages relate to an owner with a remote authorization device having a sufficient right to authorize the requested content;
(e) generating a third message in dependence upon at least the request and an owner of a remote authorization device providing a second message with insufficient rights; and
(f) providing the third message from the system to a predetermined remote authorization device, the predetermined remote authorization device associated with a user having the sufficient right.

20. A method according to claim 13 wherein,
providing the request relates to providing a request to provide a function having at least one of a minimum age requirement, a distribution list of allowed users, encryption requiring provision of a key for decryption of the function, and a protection requiring a password to release the function.

21. A method according to claim 13 wherein,
providing a second message comprises providing a second message containing a valid authorization to provide the function for at least one of a predetermined period of time, a predetermined set of data, read only events, write only events, read and write events, a predetermined file, a predetermined directory, a predetermined server connected to the system via a network, and a predetermined external peripheral device.

22. A method according to claim 21 wherein,
providing authorization to provide the function for at least a predetermined period of time further comprises the steps of providing at least one third message from the system relating to a continuation of the function and receiving a fourth message maintaining the permission for each third message.

23. A method according to claim 22 wherein,
receiving the fourth message comprises the fourth message from at least one of the same remote authorization device as that providing the initial valid authorization and a remote authorization device associated with an owner of the system.

24. A method according to claim 13 wherein,
receiving the request relates to receiving a request to provide a function on the system that is not part of at least the system and the functions already authorized by an owner of the system.

25. A method according to claim 13 wherein,
providing the system comprises providing a system comprising at least one of a CD player, an MP3 player, a DVD player, a removable memory storage device, and a multi-media player.

26. A method according to claim 25 wherein,
providing the function comprises selecting a new volume, the volume associated with at least one of a group of audio titles, a group of digital audio titles, a directory, a group of digital files, a movie and a computer game.

27. A method comprising:
(a) providing a content service provision device supporting broadcasts with at least one protocol of a plurality of broadcast protocol;
(b) requesting a content service event of a plurality of different content service events, the plurality of content service events associated with at least one content service provider of a plurality of content service providers operating with a same broadcast protocol;
(c) issuing from the content service provision device a request signal;
(d) awaiting a reply; and
(e) receiving the reply and in dependence of the reply at least one of providing the content service event and other than providing the content service event.

28. A method according to claim 27 wherein,
issuing the request signal comprises providing the request signal by at least one of broadcasting the request signal, transmitting the request signal to at least one wireless device of a plurality of wireless devices, and electronically communicating the request signal to at least one predetermined electronic device of a plurality of electronic devices.

29. A method according to claim 27 wherein,
receiving the reply comprises receiving the reply at least one of automatically from an electronic device receiving the request signal and from an electronic device in dependence of a user input provided by the user upon receiving the request signal.

30. A method according to claim 27 wherein,
an electronic device is selected from a group comprising cellular telephones, wireless gateways, personal digital assistants, removable memory storage devices, computers, computer game console, and multi-media players.

31. A method according to claim 28 wherein,
at least transmitting the request signal comprises transmitting the request signal according to a standard selected from a group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, and IMT-2000.

32. A method according to claim 28 wherein,
at least electronically communicating the request signal comprises electronic communication to a removable memory storage device inserted into a communications port of at least one of the content service provision device and an interface unit disposed between the content service provision device and the content service providers.

33. A method according to claim 28 wherein,
transmitting the request signal to at least one wireless device of a plurality of wireless devices comprises transmitting the request signal to at least a predetermined address of an electronic device of a plurality of addresses for electronic devices and transmitting the request signal to all electronic devices within range of the content service provision device.

34. A method according to claim 33 wherein
the at least a predetermined address of a plurality of addresses is selected from the plurality of addresses stored within a memory associated with the content service provision device in dependence upon at least one of the content service provision device and the content service event.

35. A method according to claim 27 further comprising:
(f) providing at least an invoice of a plurality of invoices upon receiving the reply comprising at least a valid authorization to provide the content service event.

36. A method according to claim 35 wherein,
providing the at least an invoice of a plurality of invoices comprises providing at least one of an invoice to an owner associated with the content service provision device, an owner associated with the electronic device providing the valid authorization, and all electronic devices providing replies.

37. A method according to claim 36 wherein,
the plurality of invoices are determined in dependence upon at least a set of rules, the set of rules associated with at least one of the content service provision device and the content service event.

38. A method according to claim 27 further comprising:
(f) determining that none of the received reply messages relate to valid authorization to provide the service content;
(g) transmitting a parental signal to at least one predetermined address of a plurality of predetermined addresses, the parental signal generated in dependence upon at least the content service event and an individual, the individual being one of a plurality of individual wherein each individual is associated with a device providing a reply signal; and
(h) awaiting a parental reply.

39. A method according to claim 38 further comprising:
(i) receiving the parental reply and in dependence of the reply at least one of providing the content service event and other than providing the content service event.

40. A method according to claim 38 wherein, step (i) further comprises a recipient of the parental reply contacting a dependent, the dependent being at least of an individual and other than an individual.

41. A method according to claim 27 wherein,
providing the request signal relates to providing a request for a content signal event having at least one of a minimum age requirement, a distribution list of allowed users, encryption requiring provision of a key for decryption of the function, and a protection requiring a password to release the function.

42. A method according to claim 27 wherein,
providing a reply for providing the content service event comprises providing a reply containing an authorization to provide the content service event for at least one of a predetermined period of time, only the content service event, and until receipt of second reply signal removing the authorization.

43. A method according to claim 27 wherein,
receiving the request signal comprises receiving a request signal to provide a content service event from a content service provider of the plurality of content service providers for whom there is at least one of no existing service provision subscription, a service provision subscription exists associated with a user requesting the content service event, and a service provision subscription exists associated with an intended viewer of the content service event other than the user requesting the content service event.
